(19) United States
(12) Patent Application Publication
(10) Pub. No.: US 2022/0087341 A1
(43) Pub. Date: Mar. 24, 2022

(54) SELF-DISINFECTING GLOVE COMPOSITION AND METHOD OF PRODUCTION THEREOF

(71) Applicants: L.DHRUV SAI REDDY, Chennai (IN); L.DHARIKA REDDY, Chennai (IN); ANITHA SHAIK, Plainsboro, NJ (US); ALEESHA SHAIK, Plainsboro, NJ (US)

(72) Inventors: L.DHRUV SAI REDDY, Chennai (IN); L.DHARIKA REDDY, Chennai (IN); ANITHA SHAIK, Plainsboro, NJ (US); ALEESHA SHAIK, Plainsboro, NJ (US)

(21) Appl. No.: 17/029,135

(22) Filed: Sep. 23, 2020

(51) Int. Cl. A41D 19/00; C08F 220/42; C08J 3/215; C08J 3/24; C09D 7/41

(52) U.S. Cl. CPC A41D 19/0055; C08F 220/42; C08J 3/215; C08J 2479/00; C09D 7/41; C08J 2309/00; C08J 3/247

(57) ABSTRACT

A method for manufacturing a self-disinfecting glove, the method comprising dissolving an elastomer in a solvent to form a solution, wherein the elastomer is selected from the group consisting of synthetic rubber, natural rubber, and nitrile. Adding of a photosensitizer to the elastomer solvent solution and evaporating the solvent solution to form a film, wherein the photosensitizer is selected from the group consisting of methylene blue, hypericin and titanium dioxide. Next hot pressing of the film above elastomer's melting point to form a sheet. Finally cutting, stacking and hot pressing the sheet again to enable even spread of the photosensitizer throughout the sheet.

### FIELD OF INVENTION

Embodiments of the present invention relates to a glove composition. More particularly, a self-disinfecting glove composition and method of production thereof.

### BACKGROUND

Presently the world is experiencing a pandemic due to Covid-19, wherein it has been established that one of the major routes for infection is by touching the surface contaminated with Covid-19 virus by humans.

As a result of the above mode of spreading, most of us are not even aware when encountering Covid-19 virus and because of the same preventing the spread of the disease has become a difficult task.

Various precautionary measures have been identified to both safeguard against infection as well as the spreading of the injection by the symptomatic and asymptomatic persons. Among the commonly recommended safety measures includes washing of hands regularly, using of face masks, gloves, face shields, full-body suits, maintaining social distance, etc.

Though above recommended measures may offer some degree of protection, they are not always effective. For example, a person suing glove though may not be encountering the virus may still carry the virus on the very gloves which they worn. As a result, by way of touching the other objections which user may use in the absence of gloves, the virus may spread to the user when the user encounters such objects. For example, the user of gloves may still touch objects such as their mobile phones, wallets, etc., and by touching these objects the later without gloves the user can still come in contact with the virus.

Therefore, there is a need for a self-disinfecting glove composition which may kill any pathogen as soon as it falls or contacts the glove worn by the user.

### SUMMARY

In accordance with an embodiment of the present invention, a method for manufacturing a self-disinfecting glove composition, the method comprising dissolving an elastomer in a solvent to form a solution, adding of a photosensitizer to the elastomer solvent solution and evaporating the solvent solution to form a film, hot pressing of the film above the elastomer's melting point to form a sheet and cutting, staking and hot pressing the sheet again to enable even spread of the photosensitizer molecules throughout the sheet.

In accordance with an embodiment of the present invention, the solvent comprises of distilled water and wherein the elastomer is selected from the group comprising of nitrile, natural rubber and synthetic rubber.

In accordance with an embodiment of the present invention, the preferable elastomer is nitrile.

In accordance with an embodiment of the present invention, the photosentizers molecules are selected from group consisting of methylene blue, hypericin and titanium dioxide.

In accordance with an embodiment of the present invention, wherein for evaporating the elastomer solvent solution is spread over large surface area and applied heat as evenly as possible.

In accordance with an embodiment of the present invention, the hot pressing is carried out for a time-period of 10 mins, temperature in the range of 100° C. to 108° C. and at a pressure is maintained at 50 MPa

In accordance with an embodiment of the present invention, a curing agent is added during hot pressing, wherein the curing agents are selected from group consisting of melamine, phenol, and urea formaldehyde resins.

In accordance with another embodiment of the present invention, a self-disinfecting glove composition comprising of one or more elastomers, wherein the elastomers are selected from the group consisting of synthetic rubber, natural rubber and nitrile and one or more photosensitizers, wherein the photosensitizers are selected from the group consisting of methylene blue, hypericin and titanium dioxide, wherein the self-disinfecting glove composition in presence of the visible light converts oxygen into singlet oxygen and thereby causes photo-degradation of the microbes.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a table illustrating composition of a fortified beverage, in accordance with an embodiment of the present invention.

Further, those skilled in the art will appreciate that elements in the figures are illustrated for simplicity and may not have necessarily been drawn to scale. Furthermore, in terms of the method steps, chemical compounds, and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

It is an objective of the present invention to provide a self-disinfecting glove capable of neutralizing the pathogens as soon as it falls on it.

It is an objective of the present invention to employ the process of photosensitization for killing the pathogen. As used herein the term “photosensitization” refers to a reaction to light that is mediated by a light-absorbing molecule, which is not the ultimate target. Photosensitization can involve reactions within living cells or tissues, or they can occur in pure chemical systems. Further the term “Photosensitizer” refers to a molecule that produces a chemical change in another molecule in a photochemical process.

It is an objective of the present invention to use ‘photosensitizers’ to use energy from visible light to convert oxygen into singlet oxygen, resulting in photo degradation i.e., alteration of materials by combined action of light and air. In the self-disinfecting glove composition disclosed in the present invention is capable of providing this photo degradation to effectively neutralize the pathogens and have same oxidizing capacity as bleach. Unlike antibiotics, which target specific functionalities, the composition disclosed in the present invention deals with various aspects of the microorganism rendering it impossible for the microbe to develop a defense against it.

Embodiments of the present invention discloses a self-disinfecting glove composition comprising one or more elastomers, wherein the elastomers are selected from the group consisting of synthetic rubber, natural rubber and nitrile; and one or more photosensitizers, wherein the photosensitizers are selected from the group consisting of methylene blue, hypericin and titanium dioxide, wherein the self-disinfecting glove composition in presence of the visible light converts oxygen into singlet oxygen and thereby causes photo-degradation of the microbes.

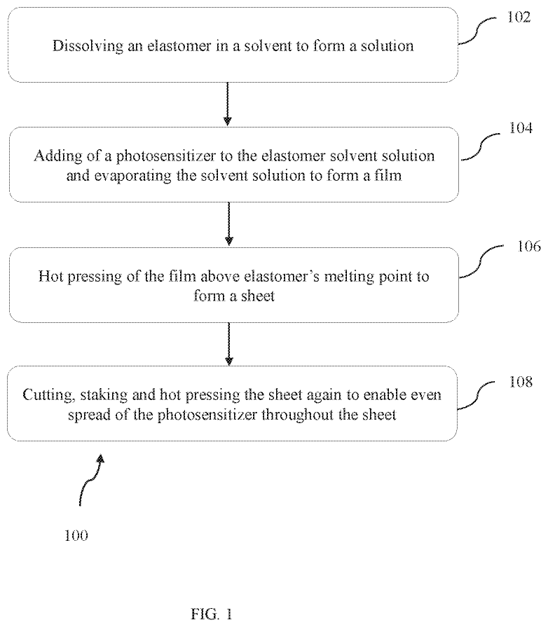

FIG. 1 illustrates a method for production of a self-disinfecting glove composition, in accordance with an embodiment of the present invention. The method comprises at 102, dissolving an elastomer in a solvent to form a solution, wherein the solvent comprises of distilled water. Further the elastomer is selected from a group consisting of nitrile, natural rubber and synthetic rubber.

At 104, the method involves adding of a photosensitizer to the elastomer solvent solution and evaporating the solvent solution to form a film, wherein the photosensitizer molecules are selected from the group consisting of methylene blue, hypericin and titanium dioxide. Further evaporating the elastomer solvent solution is spread over large surface area and applied heat as evenly as possible.

Next at 106, the method further comprises of hot pressing of the film above elastomer's melting point to form a sheet, wherein the hot pressing is carried out for a time-period of 10 mins, temperature in the range of 100° C. to 108° C. and at a pressure is maintained at 50 MPa

According to an embodiment of the present invention, melting the elastomer-photosensitizer film formed above its melting point would change its state from solid to liquid. As a result, the intermolecular spaces are increased while compared to solids and this process enables for the molecules to evenly settle layer by layer. One of the main advantages of the above step is even if the top surface is damaged the second layer of molecules would be used making the glove a destructive wall for the pathogens.

More specifically, hot pressing the film above its melting point of the elastomer to be processed eliminates all porosity and results in a final product which is 100% dense and provides nearly complete bonding of elastomer-photosensitizer molecules throughout the structure of the material.

Finally, at 108, the method involves cutting, stacking and hot pressing the sheet again to enable even spread of the photosensitizer throughout the sheet. Further a curing agent is added to cure the composition, wherein the curing agent is selected from a group consisting of melamine, phenol and urea formaldehyde resins.

### Example 1

According to an embodiment of the present invention, the elastomer comprises of synthetic rubber, wherein five grams of elastomer is dissolved in 100 ml of distilled water. Next, a one gram of photosensitizer is added to the elastomer solvent solution and the solution is evaporated to form a film. The photosensitizer molecule is selected from the group consisting of methylene blue, hypericin and titanium dioxide. Also, the evaporation of the elastomer solvent solution is carried out on a large surface area and heat is applied as evenly as possible. Further the formed film is hot pressed above the elastomer's melting point to form a sheet, wherein hot pressing is carried out for a time-period of 10 mins, temperature in the range of 100° C. to 108° C. and pressure is maintained at 50 MPa. Also curing agents selected from group consisting of melamine, phenol and urea formaldehyde resins are added for curing. Finally, the formed sheets are cut, stacked and hot pressed again to enable even spread of the photosensitizer molecules throughout the sheet.

### Example 2

According to embodiment of the present invention, the elastomer comprises of natural rubber, wherein 5 grams elastomer is dissolved in 100 ml of distilled water. According to an embodiment of the present invention, the elastomer comprises of synthetic rubber, wherein five grams of elastomer is dissolved in 100 ml of distilled water. Next, a one gram of photosensitizer is added to the elastomer solvent solution and the solution is evaporated to form a film. The photosensitizer molecule is selected from the group consisting of methylene blue, hypericin and titanium dioxide. Also, the evaporation of the elastomer solvent solution is carried out on a large surface area and heat is applied as evenly as possible. Further the formed film is hot pressed above the elastomer's melting point to form a sheet, wherein hot pressing is carried out for a time-period of 10 mins, temperature in the range of 100° C. to 108° C. and pressure is maintained at 50 MPa. Also curing agents selected from group consisting of melamine, phenol and urea formaldehyde resins are added for curing. Finally, the formed sheets are cut, stacked and hot pressed again to enable even spread of the photosensitizer molecules throughout the sheet.

### Example 3

According to embodiment of the present invention, the elastomer comprises of nitrile, wherein 5 grams elastomer is dissolved in 100 ml of distilled water. According to an embodiment of the present invention, the elastomer comprises of synthetic rubber, wherein five grams of elastomer is dissolved in 100 ml of distilled water. Next, a one gram of photosensitizer is added to the elastomer solvent solution and the solution is evaporated to form a film. The photosensitizer molecule is selected from the group consisting of methylene blue, hypericin and titanium dioxide. Also, the evaporation of the elastomer solvent solution is carried out on a large surface area and heat is applied as evenly as possible. Further the formed film is hot pressed above the elastomer's melting point to form a sheet, wherein hot pressing is carried out for a time-period of 10 mins, temperature in the range of 100° C. to 108° C. and pressure is maintained at 50 MPa. Also curing agents selected from group consisting of melamine, phenol and urea formaldehyde resins are added for curing. Finally, the formed sheets are cut, stacked and hot pressed again to enable even spread of the photosensitizer molecules throughout the sheet.

Further the self-disinfecting glove composition obtained by the above explained method comprises of one or more elastomers, wherein the elastomers are selected from the group consisting of synthetic rubber, natural rubber and nitrile, one or more photosensitizers, wherein the photosensitizers are selected from the group consisting of methylene blue, hypericin and titanium dioxide. The self-disinfecting glove composition in presence of the visible light coverts oxygen into singlet oxygen and thereby caused photo-degradation of the microbes.

It may be appreciated by the person skilled in the art that a person may not as soon as he in touching any pathogens on any surface and as a result he/she may involuntary touch their face which in turn transmits the pathogen to the person body and causes infection. Presently available gloves in the market do not protect from the pathogens completely whereas on the other hand the self-disinfecting glove composition neutralizes the pathogens as soon as it lands on the glove surface. As a result, the glove made from this self-disinfecting glove not only protects the person wearing the glove but also prevents the spread of pathogens.

The self-disinfecting glove composition disclosed in the present disclosure can be suitably moulded to produces gloves for use.

Further the self-disinfecting glove composition as disclosed in the present disclosure does not cause any rashes, it can be washed for reuse, sweat proof, inexpensive and can be used by all the frontline workers in the healthcare industry.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A method for manufacturing a self-disinfecting glove composition, the method comprising:
dissolving an elastomer in a solvent to form a solution;
adding of a photosensitizer to the elastomer solvent solution and evaporating the solvent solution to form a film;
hot pressing of the film above the elastomer's melting point to form a sheet; and
cutting, staking and hot pressing the sheet again to enable even spread of the photosensitizer molecules throughout the sheet.

2. The method as claimed in claim 1, wherein the solvent comprises of distilled water.

3. The method as claimed in claim 1, wherein the elastomer is selected from the group consisting of nitrile, natural rubber and synthetic rubber.

4. The method as claimed in claim 1, wherein the preferable elastomer is nitrile.

5. The method as claimed in claim 1, wherein the photosentizers molecules are selected from group consisting of methylene blue, hypericin and titanium dioxide.

6. The method as claimed in claim 1, wherein for evaporating the elastomer solvent solution is spread over large surface area and applied heat as evenly as possible.

7. The method as claimed in claim 1, wherein the hot pressing is carried out for a time-period 10 mins, temperature in the range of 100° C. to 108° C. and at a pressure is maintained at 50 MPa.

8. The method as claimed in claim 1, wherein curing agent is added during hot pressing.

9. The method as claimed in claim 7, wherein the curing agents are selected from group consisting of melamine, phenol and urea formaldehyde resins.

10. A self-disinfecting glove composition comprising:
one or more elastomers, wherein the elastomers are selected from the group consisting of synthetic rubber, natural rubber and nitrile; and
one or more photosensitizers, wherein the photosensitizers are selected from the group consisting of methylene blue, hypericin and titanium dioxide,
wherein the self-disinfecting glove composition in presence of the visible light converts oxygen into singlet oxygen and thereby causes photo-degradation of the microbes.
